(19) United States
(12) Patent Application Publication
(10) Pub. No.: US 2004/0031671 A1
(43) Pub. Date: Feb. 19, 2004

(54) Switch unit

(75) Inventor: Wilfried Scheuer, Gladenbach (DE)

Correspondence Address: MORRISON & FOERSTER LLP, 1650 TYSONS BOULEVARD, SUITE 300, MCLEAN, VA, 22102, US

(73) Assignee: SIEMENS AKTIENGESELLSCAFT, Munchen (DE)

(21) Appl. No.: 10/459,708

(22) Filed: Jun. 12, 2003

(30) Foreign Application Priority Data
Jun. 13, 2002 (DE) 10226402.3

(51) Int. Cl. H01H 1/10

(52) U.S. Cl. 200/512

(57) ABSTRACT

The switch unit (10) comprises an actuable button (11), which in a first region (12) is swivel-mounted on a frame (13) and in a second region (14) is directly or indirectly in operative connection with a switching element (15). The switching element (15) is suitable for triggering a switching signal when the button (11) is actuated, in that at least the part (26) of the switching element (15) triggering the switching signal is able to move by actuation of the button (11) along a straight axis (16) which is at an angle to a switching surface (17) of the switching element (15). The linear movement along the axis (16) has the effect of reducing the exposure to wear of the switch unit (10), which by virtue of its simple construction can be used universally for various button concepts.

The present invention relates to a switch unit of the generic type specified in the precharacterizing clause of patent claim 1.

In particular, the present invention relates to a switch unit which can be used for example in a front equipment panel for automobiles or the like.

Known switch units are designed as swiveling or rocking buttons, in which the actuation of the respective switching point of a switching mat or of a contact switch takes place directly or with the aid of a swiveling intermediate element.

Known switch units formed in such a way are of a complex construction, impose demanding requirements on the precision of the structural components and are exposed to increased wear.

Against this background, the present invention is based on the object of developing a switch unit of the generic type referred to at the beginning in such a way that, to reduce costs, it is intended for its components to be structurally simple and formed with relatively undemanding precision requirements, while at the same time the component wear occurring during the use of the switch unit is to be reduced.

This object is achieved according to the invention by a switch unit comprising an actuable button which in a first region is swivel-mounted on a frame and in a second region is in operative connection with a switching element which is suitable for triggering a switching signal when the button is actuated, characterized in that at least the part of the switching element triggering the switching signal is moved by actuation of the button along a straight axis which is at an angle to a switching surface of the switching element.

One advantage achieved by the present invention is that the part of the switching element triggering the switching signal does not perform a tolerance-increasing swiveling or pivoting movement when the button is actuated, but instead is moved along a straight axis in the direction of the switching means. A wear-aggravating parallel movement, with respect to a switching means, such as a printed circuit board for example, is also avoided, since at least the part of the switching element triggering the switching signal is moved along an axis which is at an angle to the switching surface.

Further details and advantages of a configuration of the switch unit according to the invention are explained in more detail below on the basis of an exemplary embodiment represented in the schematic drawing, in which:

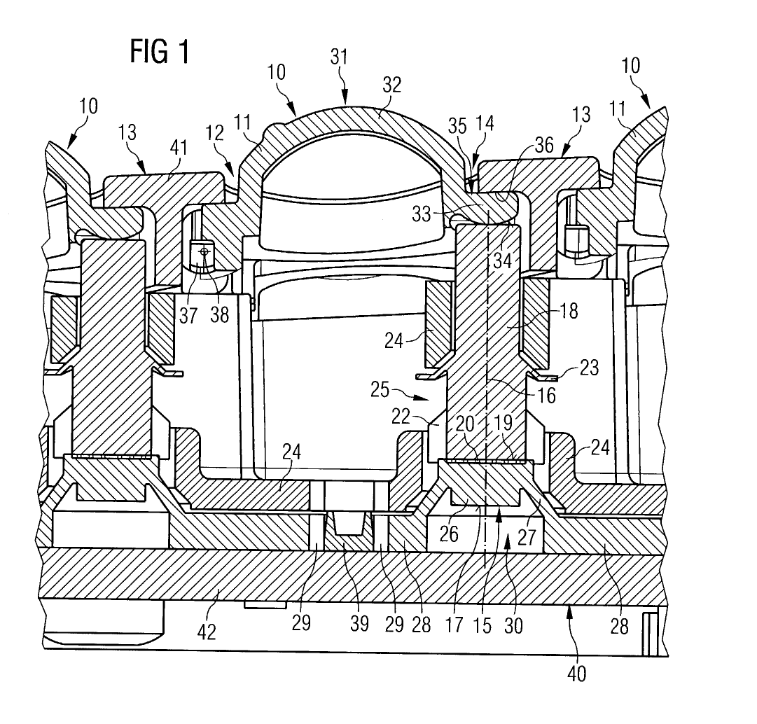

FIG. 1 shows a schematic view, partly represented in section, of a cluster of switch units with switch units according to the invention and

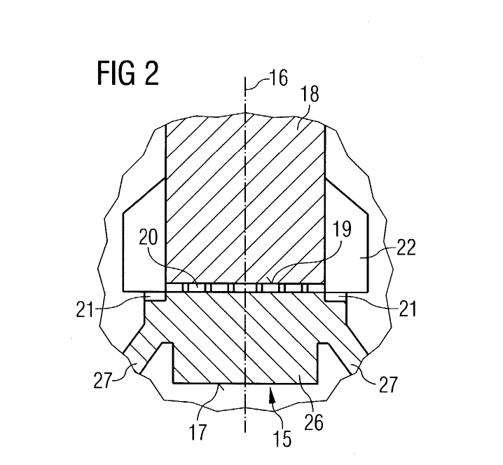

FIG. 2 shows a second section on an enlarged scale of the intermediate element of FIG. 1 in the contact region with the switching element.

Schematically represented in FIG. 1 is a detail of a cluster of switch units which has a plurality of switch units according to the invention, respectively designated generally by 10.

The respective switch unit 10 includes a button 11, which can be actuated manually from the outside, in a first region 12 is swivel-mounted on a frame 13 and in a preferably opposite, second region 14 is in operative connection with a switching element 15 in such a way that the latter triggers a switching signal when the button 11 is actuated.

According to the invention, at least the part 26 of the switching element 15 triggering the switching signal is moved by actuation of the button 11 along a straight axis 16 which is at an angle to a switching surface 17 of the switching element 15. The axis of movement (axis 16) of the switching element 15 is preferably perpendicular to the switching surface 17 of the switching element 15.

According to the embodiment represented in FIG. 1, the button 11 is in operative connection with the switching element 15 via an intermediate element 18. When the button 11 is actuated, the intermediate element 18 is moved together with the part 26 of the switching element 15 triggering the switching signal along the axis 16 in the direction of a switching means 42, for example in the form of a printed circuit board.

The intermediate element 18, preferably designed in the form of a plunger, is in continuous operative contact with the switching element 15 via a planar bearing surface 19, the bearing surface 19 of the switching element 15 lying parallel to the opposite switching surface 17.

For triggering the switching signal, when the button 11 is actuated the switching element 15 is at least partly deformed elastically, as a result of the displacement of the intermediate element 18 along the axis 16 in the direction of the printed circuit board 42.

According to the exemplary embodiment represented in FIG. 1, the switching element 15 is part of a switching mat 40, which preferably has a plurality of switching elements 15. Each switching element 15 includes a carrying element 26, which is continuously in contact with the intermediate element 18 via the bearing surface 19, represents the part triggering the switching signal and is connected in a flexurally elastic manner to a mat 28 by means of a supporting wall 27 arranged symmetrically with respect to the direction of movement (axis 16). The carrying element 26, acting as the signal-triggering part, is able to move against the flexurally elastic deforming force of the supporting wall 27 in the direction of the mat 28 when the button 11 is actuated. The mat 28 is arranged with backlash in a guide 29 and has a respective clearance 30, into which the associated carrying element 26 is able to move along the axis 16 for triggering the switching signal, in order to assume a desired switching position which is not represented in the drawing.

As additionally shown in FIG. 2 on an enlarged scale, the carrying element 26 has a receiving seat, in which a preferably dimensionally rigid disk 20 is mounted, the outer surface of the disk 20, which is exposed with respect to the carrying element 26, serving as a continuous bearing surface 19 for the intermediate element 18. The carrying element 26 is additionally provided with at least one positioning receptacle, according to the embodiment represented preferably two opposite positioning receptacles 21, in which there respectively engages in a nonpositively locking manner a positioning projection 22 of the intermediate element 18, projecting in the direction of movement (axis 16). The switching element 15 or the switching mat 40 may be made of material which is deformable in a flexurally elastic manner.

The intermediate element 18, acting as a plunger, is advantageously formed in a rotationally symmetrical manner with respect to the axis 16. According to the invention, the intermediate element 18 is displaceably arranged in a sleeve-shaped receiving element 24 of the frame 13, the receiving element 24 being suitable for keeping the intermediate element 18 in position with respect to the direction of displacement (axis 16). The receiving element 24 is provided with a clearance 25, which extends in the direction of displacement (axis 16) and into which a stop 23 projecting from the circumferential surface of the intermediate element 18 protrudes in such a way that the intermediate element 18 is displaceable together with the stop 23 over a specific displacement path along the axis 16.

In particular, the stop 23 acts together with the receiving element 24 in such a way that the displacement path of the intermediate element 18 along the axis 16 in the direction of the switching element 15 is limited. The displacement path of the stop 23 is preferably slightly greater than the path of movement of the carrying element 26, in order on the one hand to allow a free movement of the carrying element 26 along the axis 16 to assume the switching position for signal triggering, but on the other hand to prevent undesired excessive compressing of the carrying element 26 by the intermediate element 18. To facilitate assembly, the clearance 25 of the receiving element 24 is additionally limited in the direction of the button 11 by a suitable stop wall.

The button 11 has in the manual actuating region 31 a preferably curved wall 32, which according to the exemplary embodiment represented is concavely curved with respect to the switching element 15.

In the second region 14, the button 11 includes a projection 33, which has a contact surface 34 which is convexly curved with respect to the switching element 15 and acts continuously on the intermediate element 18. The projection 33 is additionally provided with a planar stop surface 35, which in the position of rest of the button 11 shown in FIG. 1 is in surface-area contact with a corresponding frame stop 36, preferably the inner side of a frame front 41, in the form of a panel.

As represented in FIG. 1, in the position of rest mentioned of the switch unit 10, the stop 23 of the intermediate element 18 does not come into contact with the stop wall of the receiving element 24 provided in the direction of the button 11. This second limitation of the receiving element 24 advantageously serves as an assembly aid. The displacement path of the intermediate element 18 or the path of movement of the switching element 15 is preferably limited in the direction of the button by the surface-area contact, produced in the position of rest of the switch unit 10, between the planar stop surface 35 of the button projection 33 and the frame stop 36.

The pivotable mounting of the button 11 on the frame 13 takes place by means of a schematically represented elastic mounting element 37, which allows the button 11, when it is manually actuated, to swivel about an axis 38 out of its position of rest, shown in FIG. 1, into its switching position, not represented in the drawing, advantageously against a restoring spring force of the mounting element 37. The button 11 is preferably made of transparent, dimensionally rigid material and can be illuminated by a diode 39 arranged in the interior of the frame, which is advantageously formed as an LED (“light-emitting diode”).

The frame 13 comprises various components which can be detachably connected to one another, according to the embodiment represented, in particular the receiving element 24, the frame front 41 in the form of a panel and further structural elements not explicitly mentioned and known from the prior art.

The way in which this switch unit 10 according to the invention functions is that, when the button 11 is manually actuated, it is swiveled clockwise according to FIG. 1 about the pivot axis 38 against a restoring spring force of the mounting element 37 and, with its projection 33, displaces the intermediate element 18 along the axis 16 in the direction of the printed circuit board 42. The carrying element 26 of the switching element 15 is pressed by the intermediate element 18 against the flexurally elastic deforming force of the supporting wall 27 along the axis 16 out of its position of rest, represented in FIG. 1, into the clearance 30 of the switching mat 40, in order to assume its switching position (not represented) and to trigger the desired switching signal.

After the button 11 has been released by the user, the button 11, the switching element 15 and the intermediate element 18 return automatically from the switching position back into the position of rest represented in FIG. 1, on account of the acting spring restoring force of the mounting element 37 and the flexurally elastic deforming force of the switching element 15, and in particular of the supporting wall 27.

The invention is not restricted to the exemplary embodiment described, but instead can be modified in a wide variety of ways. In a way corresponding to an alternative embodiment not represented, the button may be in operative connection with the switching element directly, i.e. without an intermediate element.

According to such an embodiment, the switching element may be provided with a shaft which is in the form of a plunger and extends toward the button and which functionally corresponds to the intermediate element 18 shown in FIG. 1 and is mounted in a suitable guide in such a way that at least the part of the switching element triggering the switching signal is moved by the button along an axis against an elastic restoring force. The further configuration of the switching element and the way in which this alternative embodiment functions may correspond to the example represented in FIG. 1.

The axis of movement (axis 16) of the switching element 15 does not necessarily have to be perpendicular to the switching surface 17, but instead may also extend at an angle other than 90° with respect to the switching surface 17. The axis of movement of the switching element 15 and the axis of displacement of the intermediate element 18 also do not necessarily have to be arranged coaxially in relation to each other, but instead may also lie at a distance from each other.

Furthermore, the wall 32 of the button 11 may be convexly curved with respect to the switching element 15.

It is also possible for a number of switch units 10 to be structurally and functionally combined according to the invention as a cluster of switch units, or to be used in a front equipment panel, for example of a car radio, it being possible for the button 11 to be integrated in the front equipment panel (frame front 41).

One particular advantage of the switch unit according to the invention is that it can be used without restriction for buttons with a curved wall. One of the reasons for this universal suitability for use of the switch concept according to the invention is that the shaft in the form of a plunger of the intermediate element or of the switching element can be used for all types of button of a frame front in the form of a panel with only minor changes, such as for example by changing the free shaft length.

The switch unit according to the invention comprises structurally simple parts, on which only undemanding precision requirements are to be imposed. The switching feeling of this switch unit is exactly definable, while possible tolerances in the switch system do not have adverse effects on the way in which it functions or on the switching feeling.

By avoiding a parallel movement of the switching element with respect to the printed circuit board, wearing of the switch components, in particular of the switching element, is reduced.

Furthermore, the avoidance according to the invention of a swiveling or pivoting movement of intermediate elements avoids a disadvantageous increase in existing tolerances of cooperating components.

The way in which the supporting wall 27 is formed symmetrically with respect to the axis 16 promotes a uniform and flexurally elastic deformation of the switching element 15 in the direction of movement (axis 16).

The switch unit according to the present invention has a construction which is easy to assemble, with no special or complicated tools being required for its assembly.

1. A switch unit (10), comprising an actuable button (11), which in a first region (12) is swivel-mounted on a frame (13) and in a second region (14) is in operative connection with a switching element (15) which is suitable for triggering a switching signal when the button (11) is actuated, characterized in that at least the part (26) of the switching element (15) triggering the switching signal is moved by actuation of the button (11) along a straight axis (16) which is at an angle to a switching surface (17) of the switching element (15).

2. The switch unit as claimed in claim 1, characterized in that the axis of movement (axis 16) of the switching element (15) is perpendicular to the switching surface (17) of the switching element (15).

3. The switch unit as claimed in claim 1 or 2, characterized in that, when the button (11) is actuated, the switching element (15) is at least partly elastically deformable for triggering the switching signal.

4. The switch unit as claimed in one of claims 1 to 3, characterized in that the switching element (15) has a carrying element (26), which forms the part triggering the switching signal and is connected in a flexurally elastic manner to a mat (28) by means of a supporting wall (27) arranged symmetrically with respect to the direction of movement (axis 16), the carrying element (26) being moved against the flexurally elastic deforming force of the supporting wall (27) in the direction of the mat (28) when the button (11) is actuated.

5. The switch unit as claimed in claim 4, characterized in that the mat (28) is mounted with backlash in a guide (29) and has a clearance (30), into which the carrying element (26) is able to move along the axis (16) for triggering the switching signal.

6. The switch unit as claimed in one of claims 1 to 5, characterized in that the button (11) is in operative connection with the part (26) triggering the switching signal via an intermediate element (18) and the intermediate element (18) is able to move together with the triggering part (26) along the axis (16).

7. The switch unit as claimed in claim 6, characterized in that the intermediate element (18) is in continuous operative contact with the triggering part (26) via a planar bearing surface (19).

8. The switch unit as claimed in claim 7, characterized in that the bearing surface (19) of the triggering part (26) lies parallel to the switching surface (17).

9. The switch unit as claimed in claim 7 or 8, characterized in that a dimensionally rigid disk (20), which has the bearing surface (19) for the intermediate element (18), is provided on the triggering part (26).

10. The switch unit as claimed in one of claims 6 to 9, characterized in that the triggering part (26) has at least one positioning receptacle (21), in which there respectively engages in a nonpositively locking manner a positioning projection (22) of the intermediate element (18), projecting in the direction of movement (16).

11. The switch unit as claimed in one of claims 6 to 10, characterized in that the intermediate element (18) is provided with a stop (23) which projects from its circumferential surface and acts together with the frame (13) in such a way that the axial displacement path of the intermediate element (18) is limited at least in the direction of the switching element (15).

12. The switch unit as claimed in claim 11, characterized in that the intermediate element (18) is displaceably arranged in a sleeve-shaped receiving element (24) of the frame (13), the receiving element (24) being provided with a clearance (25) which extends in the direction of displacement (16) and into which the stop (23) protrudes in such a way that the intermediate element (18) is displaceable over a specific path.

13. The switch unit as claimed in one of claims 6 to 12, characterized in that the intermediate element (18) is formed rotationally symmetrically with respect to the axis of displacement (axis 16).

14. The switch unit as claimed in one of claims 1 to 13, characterized in that the button (11) has a curved wall (32) in the actuating region (31).

15. The switch unit as claimed in claim 14, characterized in that the wall (32) of the button (11) is concavely curved with respect to the switching element (15).

16. The switch unit as claimed in claim 14, characterized in that the wall (32) of the button (11) is convexly curved with respect to the switching element (15).

17. The switch unit as claimed in one of claims 1 to 16, characterized in that the button (11) includes in the second region (14) a projection (33), which has a contact surface (34) which is convexly curved with respect to the switching element (15) and acts continuously on the switching element (15) or on the intermediate element (18).

18. The switch unit as claimed in claim 17, characterized in that the projection (33) additionally has a planar stop surface (35), which in the position of rest of the button (11) is in surface-area contact with a frame stop (36).

19. The switch unit as claimed in one of claims 1 to 18, characterized in that the swivel mounting of the button (11) on the frame (13) takes place by means of an elastic mounting element (37), which allows the button (11), when it is actuated, to swivel about an axis (38) out of its position of rest into its switching position against a restoring spring force of the mounting element (37) and, when it is released, provides that it is automatically swiveled back into the position of rest.

20. The switch unit as claimed in one of claims 1 to 19, characterized in that the button (11) is made of transparent material and can be illuminated by a diode (39) arranged in the interior of the frame.

21. The switch unit as claimed in one of claims 1 to 20, characterized in that the frame (13) comprises various components (24, 41) which can be detachably connected to one another, the frame front (41) being formed as a panel.

22. The switch unit as claimed in one of claims 1 to 21, characterized in that the switch unit (10) is arranged in a plurality as a cluster of switch units.

23. The switch unit as claimed in claim 22, characterized in that the switching elements (15) are formed together as a switching mat (40).

24. The switch unit as claimed in one of claims 1 to 23, characterized in that the button (11) of the respective switch unit (10) is integrated on a front equipment panel (41).
